(19) United States
(12) Patent Application Publication
(10) Pub. No.: US 2026/0145570 A1
(43) Pub. Date: May 28, 2026

(54) SYSTEMS AND METHODS FOR CHARGING VEHICLES

(71) Applicant: Dasher Lawless Technologies, LLC, Warren, OH (US)

(72) Inventor: Christopher Alan, Valley Glen, CA (US)

(21) Appl. No.: 19/372,061

(22) Filed: Oct. 28, 2025

Related U.S. Application Data
(60) Provisional application No. 63/721,995, filed on Nov. 18, 2024.

(51) Int. Cl. B60L 53/66; B60L 53/18; B60L 53/30; B60L 53/62; B60L 53/65; B60L 53/68; B60L 58/12; G07C 5/00; G07C 5/08

(52) U.S. Cl. CPC B60L 53/66; B60L 53/18; B60L 53/305; B60L 53/62; B60L 53/65; B60L 53/68; B60L 58/12; G07C 5/008; G07C 5/0808

(57) ABSTRACT

Methods and systems are disclosed configured to charge an electrical vehicle. A transportable vehicle charging system is electrically coupled to an electric vehicle. The vehicle charging system is configured to monitor charge rates and charge level. In response to detecting a charging fault, remedial action is taken.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### COPYRIGHT NOTICE

A portion of the disclosure of this patent document contains material which is subject to copyright protection. The copyright owner has no objection to the facsimile reproduction by anyone of the patent document and/or the patent disclosure as it appears in the United States Patent and Trademark Office patent file and/or records, but otherwise reserves all copyrights whatsoever.

### BACKGROUND OF THE INVENTION

### Field of the Invention

The present disclosure generally relates to the charging of battery powered motorized devices such as vehicles.

### Description of the Related Art

Fossil fuel-powered vehicles are a significant source of carbon emissions. According to certain estimates, 24 pounds of carbon dioxide and other global-warming gasses are emitted for every gallon of gas consumed. According to the Environmental Protection Agency, greenhouse gas emissions from transportation account for about 28 percent of total U.S. greenhouse gas emissions, making it the largest contributor of U.S. greenhouse gas emissions.

In order to reduce the emission of greenhouse gasses, battery powered vehicles are becoming an ever more important solution.

Disadvantageously, during storage and transportation of an electric vehicle, prior to delivery of the electric vehicle to a store that sells the vehicle or a vehicle purchaser, the battery may discharge and so may not be drivable when it arrives at its destination.

Further, there may be faults in the vehicle battery system which precludes it from being successfully charged in accordance with its charging specification. Conventionally, such faults may not be detected prior to delivery to a purchaser or to a store that sells the vehicle. When the fault is eventually detected, it may necessitate having the vehicle shipped back to the factory or a repair facility. Such shipment consumes an inordinate amount of energy as well as requiring the utilization of transport trucks and/or trains.

### SUMMARY

The following presents a simplified summary of one or more aspects in order to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

### BRIEF DESCRIPTION OF THE DRAWINGS

Embodiments will now be described with reference to the drawings summarized below. These drawings and the associated description are provided to illustrate example aspects of the disclosure, and not to limit the scope of the invention.

FIG. 1A illustrates an example operating environment.

FIG. 1B illustrates an example architecture.

FIG. 1C illustrates example components of a transportable charging system.

FIG. 2 illustrates an example transportable charging system.

FIG. 3 illustrates an example charging process,

### DETAILED DESCRIPTION

An aspect of the present disclosure relates to systems and methods configured to charge battery powered, motorized systems, such as electric vehicles.

Electric cars mandates are becoming ever more common, with many countries intending to phase out carbon fuel vehicles by respective deadlines. Further, many car manufacturers have announced that they intend to cease manufacturing carbon fuel vehicles. Currently, many states and countries have set deadlines at which the sale of internal combustion engine (ICE) vehicles must cease.

However, as similarly discussed elsewhere herein, electric vehicles present their own unique technical challenges as compared to ICE vehicles.

For example disadvantageously, during storage and transportation of an electric vehicle, prior to delivery of the electric vehicle to a store that sells the vehicle or a vehicle purchaser, the battery may discharge and so may not be drivable when it arrives at its destination. Further, when such vehicles are stored on a transport vehicle, such as a car carrier or a train, the electric vehicle may be relatively inaccessible to a charger and so conventionally it may not be practical to charge the electric vehicle while on the transport vehicle.

Further, there may be faults in the vehicle battery system which precludes it from being successfully charged in accordance with its charging specification. Conventionally, such faults may not be detected prior to delivery to a purchaser or to a store that sells the vehicle. When the fault is eventually detected, it may necessitate having the vehicle shipped back to the factory or a repair facility. Such shipment consumes an inordinate amount of energy as well as requiring the utilization of transport trucks and/or trains.

In order to address the foregoing technical challenges, an aspect of the present disclosure relates to an easily transportable, wheeled charging system. The transportable charging system may be easily wheeled to, loaded onto, and carried by a relatively small utility vehicle. For example, the transportable charging system may optionally be sized so that multiple (e.g., 2, 4, or 4) charging systems may be loaded onto the bed of a utility vehicle (e.g., having a 15-30 square foot bed).

The wheeled charging system may comprise a gas or diesel electrical generator and/or a battery used to charge electric vehicles. Optionally, the charging system may incorporate renewable energy sources, such as solar panels, to provide a more sustainable and grid-independent charging solution.

Thus, this transportable charging system offers a flexible and controlled solution for charging electric vehicles in various locations, optionally with a computer system ensuring efficient and safe operation, and the optional retractable charging cable providing convenience and cable management.

The transportable charging system may include and be controlled by a computer system, such as programmable logic controller (PLC), and may be equipped with a retractable charging cable as described herein. In addition, as described herein, the transportable charging system may include one or more user controls, such as a touch display, buttons, switches, rotary controls, LED indicators, a keypad, and/or the like. For more advanced user interactions, the PLC may integrate with dedicated. human-machine interfaces (HMIs) and/or supervisory control and data acquisition (SCADA) systems

This program logic may include sequences for initiating charging, monitoring charging progress, and handling error conditions. For example, when a vehicle is connected and charging is requested, the PLC may activate the appropriate power supply and start monitoring parameters such as voltage, current, and temperature. The PLC may also optionally handle safety interlocks, such as ensuring that the vehicle is properly connected and that there are no faults in the charging circuit.

The PLC may be configured to support remote monitoring and control capabilities, enabling operators and/or remote systems to monitor charging status, adjust parameters, and diagnose faults from a centralized control facility and/or through a web interface. This enables efficient management of charging infrastructure across multiple charging systems and locations.

The transportable charging system may comprise a ruggedized and weatherproof enclosure mounted on a wheeled base or a skid, making it easily transportable to various locations. The enclosure may house a power distribution panel, the PLC unit, and a charging cable management system.

The power distribution panel may be configured to receive and distribute electrical power from a suitable source, such as a grid connection or an internal generator or battery pack. The transportable charging system may comprise safety components, such as circuit breakers, surge protectors, and/or isolation transformers.

The PLC may control and monitor various functions. For example, optionally the PLC is programmed to handle some or all of the following tasks.

Where the retractable charging cable system is motorized the retractable charging cable system may comprise a motorized cable reel or spool. The PLC may control the retractable charging cable system, extending or retracting the cable as needed, ensuring a neat and organized cable management solution.

The PLC may interface with user interfaces, such as a touchscreen display or control panel (e.g., comprising buttons, switches, sliders, and/or the like), enabling users to initiate and monitor the charging process, select charging modes (e.g., Level 2 or DC fast charging), specify charge fill levels (e.g., 25% capacity, 50 capacity, 100% capacity) and access system diagnostics.

The PLC may be configured to monitor and record the energy consumption during charging sessions, enabling accurate billing or reporting.

The PLC may continuously monitor various system parameters, such as voltage, current, and temperature, to ensure safe operation. In case of a detected fault or abnormal condition (e.g., where the voltage, current, and/or temperature exceeds a first threshold of falls below a second threshold), the PLC may initiate appropriate actions, such as shutting down the system, reducing the charging current, triggering alarms, and/or transmitting corresponding messages over a wireless network to one or more electronic destinations (e.g., messaging addresses, email addresses, applications, vehicle charging management systems, etc.).

The PLC may incorporate safety features including ground fault detection, overcurrent protection, and emergency stop functionality. These features help ensure that the charging process is conducted safely and reliably.

The PLC may comprise a processing device including one or more arithmetic logic units, multiple storage registers, and/or onboard memory. The processing device may be configured to execute one or more control programs (e.g., accessed from memory) and to perform logical operations. The processing device may manage data transfers between various components of the PLC. The PLC may comprise memory (e.g., (ROM/EPROM/Flash memory) for storing program instructions, data, and system configurations.

The PLC may comprise an Input/Output (I/O) system that acts as an interface between the PLC and the physical world, enabling the PLC to monitor and control various devices and processes. The PLC may include one or more input modules (e.g., comprising an analog to digital converter) configured to receive signals from sensors, switches, and other input devices, and convert them into digital signals that the CPU can process. The PLC may include one or more output modules configured to receive signals from the processing and convert them into appropriate output signals (e.g., voltage, current) to control actuators, motors, valves, or other output devices. For example, an output module may include a digital-to-analog converter configured to convert digital signals from the processing device to analog signals to thereby interface with analog controlled devices. The I/O modules may include modules located within the PLC housing and/or distributed remotely using communication networks.

Inputs to the input module may include sensors for detecting whether a vehicle is connected, measuring voltage and current, and monitoring environmental conditions. Outputs of the output module may be connected to relays and/or contactors for controlling power flow, as well as indicators for status feedback.

A programming device, such as a dedicated programming terminal or a computer with programming software may be utilized to write, upload, and modify the control program stored in the PLC's memory. Programming may be performed using one or more programming languages, such as Ladder Diagram (LD), Structured Text (ST), Function Block Diagram (FBD), or Instruction List (IL).

The PLC may include or be coupled to one or more wired or wireless communication interfaces (e.g., Ethernet, serial ports (RS-232, RS-485), fieldbus protocols (e.g., Profibus, DeviceNet, Modbus, and/or the like), cellular modems, Wi-Fi, Bluetooth, and/or the like) to enable communication with other devices, such as human-machine interfaces (HMIs), supervisory control and data acquisition (SCADA) systems, other PLCs, a vehicle data analytics system, and/or other devices and systems.

The PLC may include a real-time clock and calendar module, which enables time-based operations, scheduling tasks, and/or time-stamping of events or data (such as events and data described herein).

The transportable charging system for electric vehicles, equipped with a programmable logic controller (PLC) and diagnostic capabilities, can detect, access, and/or report various types of issues and diagnostics related to the vehicle charging process. For example, some or all of the following may be determined and reported (e.g., stored in memory for later access, transmitted periodically and/or in real-time to another system, transmitted via a messaging service or email, to a vehicle charging management system, and/or the like):
Charging session data:
   Start and end times of each charging session
   Duration of the charging session
   Energy delivered (kWh) during the session
   Charging rate (kW) over time
   Battery state of charge (SoC) at the start and end of the session
   Battery state of health (SoH)
Vehicle and charging system identification:
   Vehicle make, model, and year
   Vehicle identification number (VIN)
   Charging system ID or serial number
   Location of the charging session (if equipped with GPS)
Charging protocol and standard:
   Charging protocol used (e.g., SAE J1772, CCS, CHAdeMO)
   Charging level (Level 1, Level 2, or DC fast charging)
   Maximum supported charging rate
Fault and error codes:
   Error codes from the vehicle's battery management system (BMS)
   Fault codes from the charging system's components
   Communication errors or failures between the vehicle and charging system
Power quality and electrical parameters:
   Voltage, current, and power factor measurements
   Electrical ground fault detection
   Over-voltage or under-voltage conditions
   Environmental and safety monitoring:
   Ambient temperature and humidity
   Charging cable temperature
   Ground fault detection
   Emergency stop events or safety interlock activations
User and access control information:
   User authentication or identification (if applicable)
   Access times and durations
   Billing or payment information (if integrated with a payment system)
   Maintenance and service logs:
   Charging system component usage and wear
   Scheduled maintenance reminders
   Service history and records
Communication failures:
   Failure to establish communication between the vehicle and the charging system
   Loss of communication during the charging process
Incompatible charging protocol or handshake failure
Vehicle-side failures:
   Vehicle battery management system (BMS) faults or errors
   Vehicle on-board charger malfunctions
   Vehicle inlet or charging port issues
   Charging system failures:
Power supply or converter failures
   Cable or connector faults (e.g., broken cables, loose connections)
   Control board or PLC malfunctions
   Ground fault detection
   Power quality issues:
   Over-voltage or under-voltage conditions
   Electrical surges or spikes
   Excessive harmonic distortion
Thermal management failures:
   Overheating of the charging cable or connectors
   Inadequate cooling or ventilation
   Safety system failures:
   Emergency stop system failures
   Interlock or safety sensor malfunctions
   Ground fault detection failures
Authentication or authorization failures:
   Invalid user credentials or access rights (if applicable)
   Payment processing failures (if integrated with a payment system)
   Network or communication failures:
   Failures in remote monitoring or data transmission
   Connectivity issues with backend systems or servers

The charging system's PLC, in conjunction with various sensors and monitoring components, can continuously monitor the charging process and detect these failures. Upon detection, the PLC can initiate appropriate actions, such as:
Generating error codes or fault logs
Triggering alarms or notifications (which may be wirelessly transmitted to one or more destinations, such as a vehicle charging management system, which may determine a remedial action to be taken)
Shutting down the charging process safely
Displaying error messages or guidance on user interfaces
Initiating troubleshooting or maintenance procedures

These diagnostics may be recorded, stored, and analyzed by the PLC or a connected monitoring system, providing useful insights into the charging process, system performance, and potential issues. This information can be used for troubleshooting, maintenance planning, billing purposes, and optimizing the overall charging infrastructure. By way of illustration, if an issue is detected while charging the vehicle during transportation to a dealer, the vehicle can be pulled off the transporter and can instead be transported to a repair facility.

For example, if a vehicle's charge rate is to be determined to be abnormally slow, it may be determined that the vehicle has a charging system and/or battery problem that needs to be rectified. By way of illustration, the actual charge rate determined from data accessed by the charging system may be compared against an expected charge rate accessed from memory. For example, the charge rate of each electrical vehicle model for a given charge level type (e.g., level 1, level 2, level 3) and battery size may be stored in memory. The vehicle make, model, year, vehicle identification number, and/or charging system ID/serial number acquired from the vehicle by the charging system may be used to locate the corresponding charge rate information from memory. If the actual charge rate varies by more than a specified threshold amount (optionally taking into account the current temperature as measured using a temperature sensor or as accessed from over a network from a weather data source), a determination may be made that there is a fault with the vehicle battery or charging system and appropriate remediation action may be taken. If the actual charge rate does not vary by more than the specified threshold amount (optionally taking into account the current temperature), a determination may be made that the vehicle battery or charging system is operating within specification and the vehicle may accordingly be delivered to the previously specified destination.

By detecting and reporting such charging failures, the charging system can ensure safe and reliable operation, minimize downtime, and enable proactive maintenance and troubleshooting, ultimately improving the user experience and the overall efficiency of the electric vehicle charging infrastructure.

Additionally, the system may be configured to enable remote monitoring and control capabilities, so that operators can monitor and manage the charging system remotely.

As discussed above, the retractable charging cable may be motorized. Optionally, the retractable charging cable may be manually deployed. For example, the retractable charging cable may comprise a heavy-duty, weather-resistant cable designed for outdoor use. The cable may be connected to the charging outlet(s) on the system enclosure and can be extended to reach the electric vehicle's charging port. The manual cable management system may be configured to ensure that the cable is retracted neatly and safely when not in use, preventing trip hazards and minimizing cable wear and tear.

In order to reach an electric vehicle stored on a transport vehicle, the wheeled charging system may comprise a reel configured to have a long charging cable stored thereon (e.g., a 20, 40, 60, 80, or 100 foot long). The reel may be ratcheted. A ratcheted cable reel is a mechanism designed to spool and manage cables or wires efficiently while reducing or eliminating tangling and damage to the cable. The ratcheted cable reel may comprise a drum and a ratchet mechanism. The drum comprises a central cylindrical component around which the cable is wound. The drum may be configured to rotate freely on an axle or shaft. The ratchet mechanism comprises a gear wheel with teeth on its perimeter and a pawl (e.g., a hinged lever) that engages with the perimeter teeth. The pawl permits rotation in only one direction while preventing backward movement. When the cable is being deployed (e.g., by a user pulling on an end of the cable, such as the charging cable, or by a user rotating a handle attached to the reel), the drum rotates in the desired direction and the pawl engages with the teeth on the gear wheel. The teeth grip the pawl, allowing the drum to rotate.

Once the cable is pulled out to the desired length, or if there's tension on the cable pulling it back, the pawl prevents the drum from rotating backward. This prevents the cable from unwinding unintentionally. To release the cable, a release button or lever may be active, enabling the drum to rotate freely in either direction, so that the cable may be wound or unwound as needed.

The charging cable (whether a manual or motorized reel is used) may be equipped with one or more charging plugs. Optionally, the charging cable may be equipped with a charging plug compatible with a given standard, and adapters may be utilized to be used with electric vehicles equipped with connectors compatible with different standards.

Example charging plugs may include some or all of the following:
Type 1 (SAE J1772) plug: a standard plug used in North America and Japan, where the vehicle has a J1772 connector on the vehicle side. Type 1 (SAE J1772) is compatible with Level 1 and Level 2 charging stations.
Type 2 (IEC 62196 or Mennekes) plug: used in Europe and elsewhere. It has a Mennekes connector on the vehicle side and is compatible with both AC and DC charging.

CCS (Combined Charging System) plug: The CCS plug is an extension of Type 2 plugs and includes additional pins for high-speed DC charging.

CHAdeMO: a DC fast charging standard used by Japanese and Korean automakers.

Tesla Connector: a proprietary connector for charging, which is compatible with Tesla's Supercharger network as well as with adapters for other charging standards.

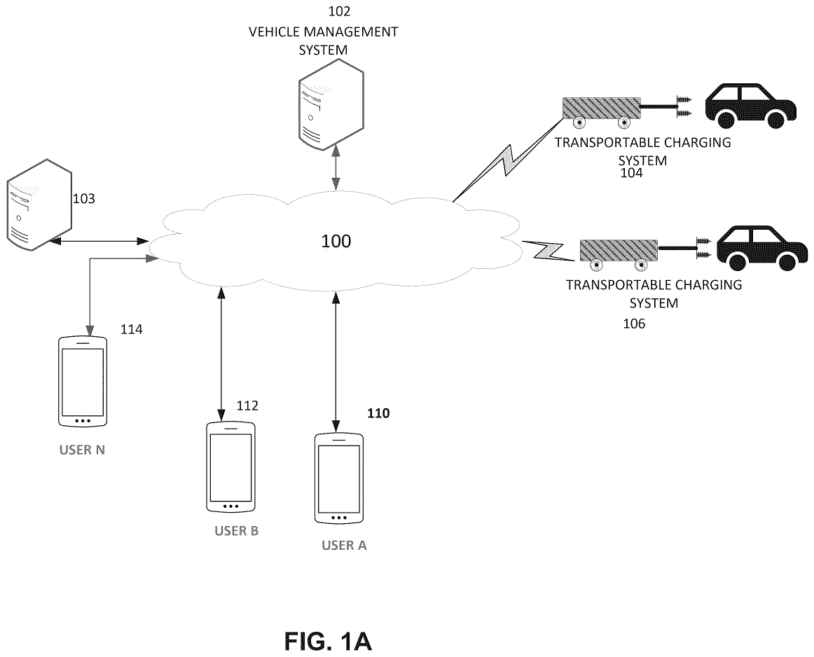

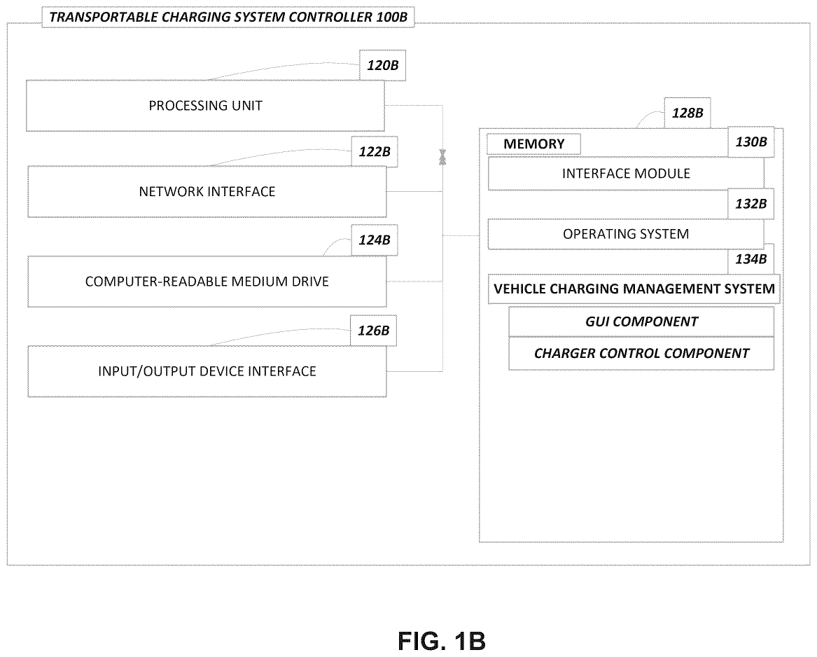

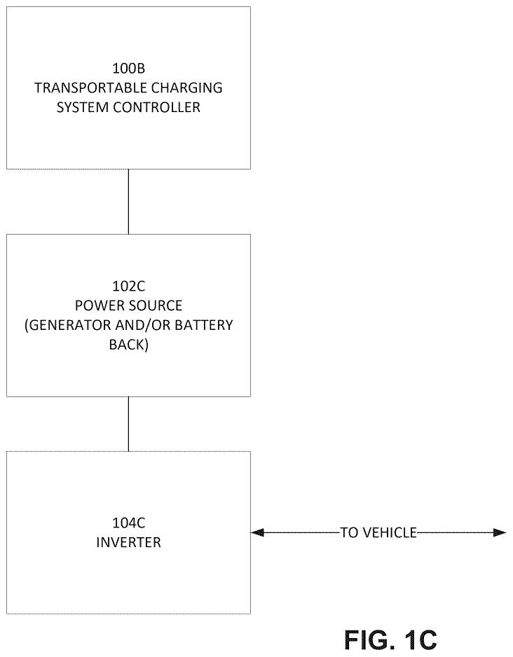

Referring now to FIG. 1A, an architecture is illustrated that may be utilized to enable electric vehicles to be charged via a portable charger, enables charging data to be collected, enables vehicle faults to be detected (e.g., charging faults), and enables vehicle faults to be remediated.

The various systems and devices may communicate with each other over one or wired and/or wireless networks 100 (e.g., the Internet, Ethernet, or other wide area or local area network).

A vehicle charging management system 102 may be utilized to collect data from one or more transportable charging systems 104, 106, such as those described herein. The data transfer may be initiated by a transportable charging system based on a detected event (e.g., a detected vehicle fault), at specified intervals (where such intervals may be stored in memory), and/or at scheduled times (where such scheduled times may be stored in memory). Optionally, the data may be transmitted from a transportable charging system to the vehicle charging management system 102 in response to a request for all or selective data from the charging management system 102. Optionally, only new data (relative to previous transmissions) is transmitted by a given transportable charging system to the vehicle charging management system 102 to thereby reduce memory, network interface, and network bandwidth utilization.

Based on the collected data, the vehicle charging management system 102 may be configured to take certain actions. For example, if a given transportable charging system detects and optionally reports that a vehicle is not charging at all, is charging too slowly or is not fully charging, the vehicle charging management system 102 may be configured to take remedial action, such as initiating an order to have the vehicle removed from a vehicle transport (e.g., a train or a transporter vehicle) or storage/parking location and transported to a repair location for further diagnosis and repair.

A data collection system 103 may be connected to one or more remote vehicle charging management systems 102, and may aggregate data received from the vehicle charging management systems 102. The data collection system 103 may collect data from the vehicle charging management systems, such as some or all the sensor data and data provided by vehicles during charging collected by the vehicle charging management systems from transportable charging systems and/or some or all of the commands issued by, and actions taken by the vehicle charging management systems. The data (such as the data discussed herein) may include identifiers associated with respective vehicles, and may include vehicle make and model data.

The data collection system 103 may use such charging and vehicle-related data to generate corresponding electronic reports (e.g., PDF reports, XML files, and/or the like) which may be transmitted to one or more electronic destinations. The reports may include some or all of the data captured from the also indicate, in association with vehicle identifiers (e.g., VIN).

In the illustrated embodiment, the vehicle management system 102 and/or data collection system 103 may be hosted on one or more servers. The vehicle management system 102 and/or data collection system 103 may be cloud-based and may be accessed by one or more user devices 110, 112 over the network 100.

User devices 110, 112, 114, transportable charging systems 104, 106, vehicle charging management system 102, and/or data collection system 103, may be configured to share software applications, computing resources, and data storage.

Optionally, a software application configured to interact with transportable charging systems 104, 106 and/or the vehicle charging management system 102 may be downloaded from the vehicle charging management system 102 and/or an application store to one or more of the user devices 110, 112, 114. Optionally, functionality provided by the software application may be instead or in addition be accessed via a web browser hosted on a user device from a remote web server.

The software application may optionally enable a user to communicate with, obtain data from, or transmit commands to a given transportable charging system 104, 106, vehicle management system 102 and/or data collection system 103. For example, a user device may be configured to access some or all of the data discussed herein (e.g., collected and/or generated by a given transportable charging system 104, 106).

The user devices 110, 112, 114 may be in the form of a desktop computer, laptop computer, tablet computer, mobile phone, smart television, smart wearable device (e.g., a smart watch, smart eyeglasses, etc.), cloud-based system, a system mounted in a user vehicle, and/or other computing system. A user device may include user input and output devices, such displays (touch or non-touch displays), speakers, microphones (e.g., to accept voice commands or to enable voice calls), trackpads, mice, pen input, printers, haptic feedback devices, cameras, and/or the like. A user device may include wireless and/or wired network interfaces (e.g., Bluetooth, Wi-Fi, and/or other network interfaces) via which the user may communicate with the vehicle charging management system 102, the data collection system 103, transportable charging systems 104, 106, and/or other systems and devices over one or more networks.

User interfaces described herein are optionally configured to present data (optionally in real time) from sources described herein and to receive user data and commands, which may optionally be executed by the vehicle charging management system 102 (and/or other systems described herein), optionally in real time.

FIG. 1B is a block diagram illustrating an embodiment of example components of a controller 100B in the transportable charging system. The example transportable charging system includes an arrangement of computer hardware and software components that may be used to implement aspects of the present disclosure. Those skilled in the art will appreciate that the example components may include more (or fewer) components than those depicted in FIG. 1B.

The transportable charging system controller 100B may be configured to regulate the power output of the transportable charging system to match the specifications of a given electric vehicle being charged. For example, the transportable charging system controller 100B may manage the charging process by communicating with the vehicle to determine the appropriate charging rate, monitor the state of charge, and to ensure safe operation. As similarly discussed elsewhere herein, the system may charge a vehicle using one or more charging standards (e.g., CHAdeMO, CCS, Tesla's proprietary system, and/or other standards).

The transportable charging system controller 100B may include one or more processing units 120B (e.g., a programmable logic controller (PLC), a general purpose processor and/or a high speed graphics processor with integrated transform, lighting, triangle setup/clipping, and/or rendering engines), one or more network interfaces 122B, a non-transitory computer-readable medium drive 124B, and an input/output device interface 126B, all of which may communicate with one another by way of one or more communication buses. The network interface 122B may provide connectivity to and communications with one or more networks or computing systems (e.g., one or more of the systems and devices illustrated in FIG. 1A). The network interface 122B may comprise a cellular modem, a WiFi modem, and/or the like.

The processing unit 120B may thus communicate information and instructions to and/or from other computing devices, systems, or services via a network. The processing unit 120B may also communicate to and from memory 124B and further provide output information via the input/output device interface 126B. The input/output device interface 126B may also accept input from one or more input devices, such as a keyboard, mouse, digital pen, touchscreen, switches, buttons, slide switches, microphone, camera, other sensors, etc.

A programmable logic controller may be configured to continuously monitor the state of input devices and make decisions using a user-specified program to control the state of output devices (e.g., energize or de-energize output devices connected to the PLC). For example, the sensor devices may include current sensors, voltage sensors, temperature sensors, charge sensors, and/or the like. Output devices may include motors, actuators, solenoids, relays, charging systems, displays, light indicators, audible alarm/indicator systems, printers, and/or the like.

The programmable logic controller may include a central processing unit, RAM and ROM/EEPROM, analog inputs (connected to an internal analog to digital convertor), analog outputs (from an internal digital to analog convertor), digital inputs/outputs, and/or the like. The programmable logic controller may be an integrated chip or may comprise one or more interconnected physically separate modules.

The programmable logic controller may be programmed using a Ladder Diagram, Sequential Function Charts, a Function Block Diagram, Structured Text, an Instruction List, and/or other programming techniques.

The memory 128B may store computer program instructions that the processing unit 120B may execute in order to implement one or more aspects of the present disclosure. The memory 120B generally includes RAM, ROM (and variants thereof, such as EEPROM), magnetic disc drives, optical disc drives, and/or other persistent or non-transitory computer-readable storage media. The memory 120B may store an operating system 132B that provides computer program instructions for use by the processing unit 120B in the general administration and operation of the transportable charging system, including its components. The operating system 132B may be a real time operating system (RTOS).

The memory 128B may store vehicle identifiers for vehicles that the system has been connected to, data received from such vehicles, and/or charge data (e.g., beginning charge level, final charge level/state of charge, charge/energy delivery rate, charging voltage levels, charging current levels, battery capacity, start charging time, end charging time, total charging time, other data disclosed herein, and/or the like). In addition, data generated by the transportable charging system (e.g., the number of vehicles charged, number of and/or which vehicles were determined to have a charging or other fault, optionally over a specified time period, the total time spent charging vehicles, temperature sensor readings over time, charge level history of the system battery pack (where such is present), fuel level (where the system includes a generator such as described herein), errors or faults encountered during the charging process (e.g., overcurrent, undervoltage, ground fault, excessive temperatures, communication failures, and/or the like), real-time status of the system (e.g., available, in use, or out of service). and/or other such data discussed herein), user interaction data (e.g., user identifiers, commands provided by users, and/or the like), network connectivity data (e.g., how long and to which networks the system was connected to), and/or the like.

Optionally, in addition or instead, the data may be transmitted to and stored remotely on a cloud-based or other networked data store. The data may optionally be stored in a relational database, an SQL database, a NOSQL database, a hierarchical database, an object oriented database, a graph database, and/or other database type.

The memory 128B may include an interface module 130B. The interface module 130B may be configured to facilitate generating one or more interfaces through which a compatible computing device may send data to, or receive data from the vehicle charging management module 134B.

The modules or components described above may also include additional modules or may be implemented by computing devices that may not be depicted in FIGS. 1A and 1B. For example, although the interface module 130B is identified in FIG. 1B as a single module, the module may be implemented by two or more modules and in a distributed manner. By way of further example, the processing unit 120B may include a PLC and a graphics processing unit (GPU). The system may offload compute-intensive portions of the applications to the GPU, while other code may run on the PLC. The GPU may include hundreds, or thousands of core processors configured to process tasks in parallel. The GPU may include high speed memory dedicated for graphics processing tasks. As another example, the systems described herein and their components can be implemented by network servers, application servers, cloud-base systems, database servers, combinations of the same, or the like, configured to facilitate data transmission to and from data stores, and other party systems via one or more networks. Accordingly, the depictions of the modules are illustrative in nature.

Referring to FIG. 1C, the transportable system controller 100B may be electrically connected to a power source (e.g., a gas/diesel powered generator and/or a battery pack, such as those discussed herein). The power source 102C may be electrically coupled to an inverter/converter 104C, which in turn may be coupled to a vehicle via a cable for charging and/or data collection.

Where the transportable charging system includes a battery pack for charging vehicles, the transportable charging system may comprise power electronics configured to access DC power from the battery pack and provide charging power to vehicles. The power electronics may include an inverter/converter 104C that converts the DC power from the battery pack to the appropriate DC or AC voltage and current required by the electric vehicle's charging system. If the vehicle uses AC charging (Level 1 or Level 2), the inverter 104C converts DC to AC. For DC fast charging, the battery pack directly supplies DC to the vehicle.

Where the transportable charging system includes a generator (e.g., a gas or diesel powered generator) for charging vehicles, the transportable charging system may comprise power electronics configured to access AC power from the generator and provide charging power to vehicles. The power electronics may include an inverter/converter 104C that converts the AC power from the battery pack to the appropriate DC voltage (e.g., for fast charging) or AC voltage and current required by the electric vehicle's charging system. The power electronics may provide voltage regulation that ensures that the voltage and current delivered to the vehicle are within specified safe and acceptable limits. The generator may optionally be configured to generate power in the range of 6.5 kW-350 kW.

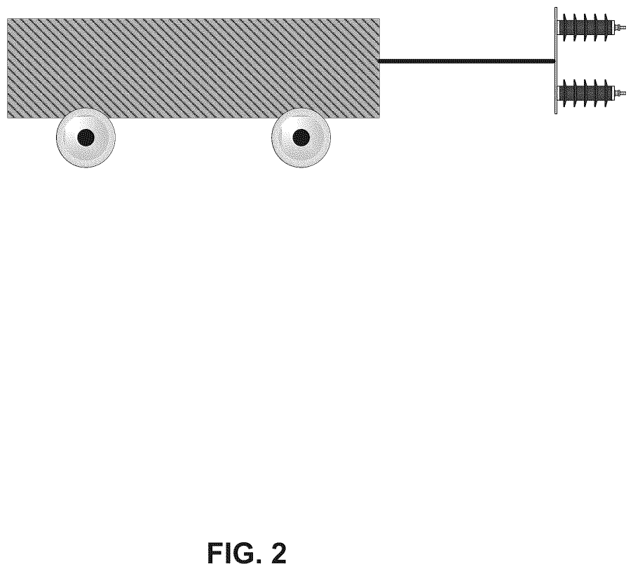

FIG. 2 illustrates an example transportable charging system comprising a wheeled enclosure and an extendable charging cable with a connector configured to mate with a vehicle connector to charge the vehicle and to collect data from the vehicle, such as the cables and connector discussed herein discussed herein. The enclosure may house the circuits and components illustrated in FIGS. 1B, 1C, including a gas or diesel generator configured to generate electricity to charge vehicles and/or power the transportable charging system, and/or a battery configured to charge vehicles and/or power the transportable charging system.

Where the transportable charging system includes a battery, it may comprise a high-capacity battery pack, which stores electrical energy that can be transferred to the electric vehicle. The battery pack capacity may optionally be in the range of several kilowatt-hours (kWh) (e.g., 60 kWh-300 kWh) to enable one or more vehicles to be fully charged. The battery pack may comprise lithium-ion batteries which advantageously have high energy density and reliability. Optionally, solid-state batteries may be utilized for enhanced safety and efficiency. The transportable charging system may comprise a cable reel such as discussed herein.

A panel (which may comprise a touch screen or other display and/or physical buttons, knobs, sliders and/or other physical controls) may be affixed the housing (e.g., to an external wall of the housing) or the panel may be in the form of a portable computer tablet that wirelessly communicates with the transportable charging system and may be stored in a receptacle attached to or formed by an enclosure wall. The display may be configured to provide real-time information such as battery status, charging speed, time remaining until charging complete, vehicle information (e.g., make, model, VIN, and/or the like), and/or error messages.

Some or all of the information displayed by the panel may also be viewable via a user device (e.g., a mobile phone, tablet, laptop, desktop, other devices discussed herein, and/or the like). For example, an application installed on the user device may wirelessly receive in real time data to enable users to monitor the charging process, configure settings, monitor fuel/battery levels, and receive notifications remotely. Optionally, the foregoing user interfaces, and corresponding functionality, may be provided via a webpage accessed by a browser on the user device. The webpage may be accessed from a server hosting the webpage and corresponding website. Optionally, the server may be associated with one or more of the systems discussed herein (e.g., the vehicle management system 102 and/or data collection system 103).

The controls may be configured to enable the user to start or stop the charging of a vehicle, adjust settings, and/or to switch between different charging modes (e.g., slow charging, fast charging, and/or the like).

The enclosure may include a cooling system to mitigate the heat generated by charging a vehicle. The cooling system may comprise air cooling (e.g., a fan) and liquid cooling to ensure safe operating temperatures are maintained for the battery pack (when used) and power electronics. Optionally the power electronics and/or other components may be mounted on heatsinks to better dissipate heat generated by such components. The system may include one or more temperature sensors that monitor temperatures within the battery pack (when present) and power electronics, and that trigger a system or charging shutdown or throttling if it is determined that the temperature exceeds a temperature threshold.

Optionally, the transportable charging system may include fuses and/or circuit breakers to protect the system from overcurrent conditions (wherein a fuse may open or a circuit breaker may trip and open) when the current exceeds a selected threshold. Optionally, ground fault detection is provided to ensure that leakage of current to ground is detected and mitigated. For example, a ground fault occurs when there is an unintended connection between an electrical circuit and the ground. This can cause current to flow through unintended paths, potentially leading to electric shock, equipment damage, and/or fire. A ground fault detection system may be utilized that monitors the difference between the current flowing into the system and the current returning. If there is a discrepancy (indicating that current is leaking to the ground), a ground fault is detected. Such leakage may be stopped using a Ground Fault Circuit Interrupter (GFCI) that quickly shuts off power when it detects a ground fault. The GFCI monitors the current flowing through the hot (live) and neutral wires. If the currents differ beyond a specified threshold (e.g., 4-10 mA), the GFCI trips and cuts off the power supply.

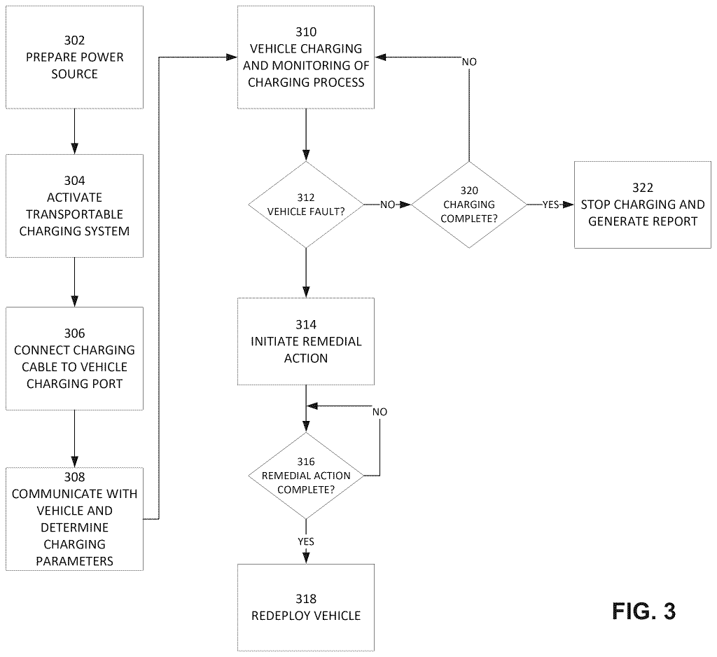

An example charging, fault detection, and remediation process will not be described with reference to FIG. 3.

At block 302, a power source of the transportable vehicle charging system (such as described herein) is prepared for charging a vehicle. For example, if the power source comprises a battery pack, the battery pack may be charged via a grid source or otherwise. If the power source comprises a generator, a generator fuel tank may be filled with the appropriate fuel (e.g., gas, diesel, or other fuel).

Prior to or after the power source is prepared, the transportable vehicle charging system may be transported to a location (e.g., using a pickup truck, utility vehicle, or otherwise), where one or more electric vehicles are to be charged. The transportable vehicle charging system may be placed on a stable, flat surface within cable range of a vehicle's charging port to ensure safe and efficient operation.

At block 304, the transportable vehicle charging system (which may be referred to as a charging system) may be turned on. Optionally, the transportable vehicle charging system may run a self-diagnostics process to ensure that its various components and circuits are functioning properly. If a charging generator is present, the generator may be turned on.

At block 306, the charging cable is connected to the vehicle charging port, such as one of the types of charging ports described herein. At block 308, the transportable vehicle charging system controller may communicate with the vehicle (e.g., the vehicle computer system) over the cable to determine the appropriate charging parameters (voltage, current, etc.), a vehicle identifier, a vehicle make, a vehicle model, and/or the like. Such data may be used by the charging system to ensure that the charging system delivers power within the vehicle's specified limits and specifications. The charging system and/or vehicle may perform a safety check to confirm there are no faults, such as ground faults or short circuits, before beginning the charging process. If such faults are detected, a remediation process, such as discussed with respect to block 314, may be performed. For example, the charging operation may be interrupted. A notification may be transmitted to one or more destinations (e.g., email addresses, text message addresses, software application programming interfaces, and/or the like). The notification may include some or all of the information collected from the vehicle and/or generated by the charging system that is related to the vehicle (e.g., vehicle identifier, fault type information and/or identifier (e.g., an error or fault code that may identify errors or faults discussed herein), and/or the like). Remediation action may be taken, such as having the vehicle transported to a repair location or having a person at the charging location take certain actions (e.g., resetting or rebooting the vehicle computer and/or drive system).

Assuming no material faults are detected, at block 310, the charging system may automatically begin charging the vehicle (or may begin charging the vehicle in response to a user instruction) and may monitor the charging process in accordance with the determined charging parameters.

The charging system may employ adaptive charging, where the charging system adjusts the power output dynamically to match the electric vehicle's battery needs, optionally optimizing for efficiency and safety. The vehicle's battery management system (BMS) may request the charging system to lower power as the battery nears full charge.

The charging system may activate its cooling systems (fans, liquid cooling, etc.) as needed to prevent overheating of the charging system and associated devices and components.

With respect to monitoring, the charging system may monitor current charging power (e.g., in kW), energy delivered (e.g., in kWh), battery state of charge, the state of health of the battery, and/or charging duration.

The state of charge (SoC) of a battery describes the difference between a fully charged battery and the same battery in use, and is indicative of the remaining quantity of electricity available in the cell. The state of charge may be defined as the ratio of the remaining charge in the battery, divided by the maximum charge that can be delivered by the battery. SoC may be expressed as a percentage as below.

$$SoC / \% = 100 ( {Q}_{0} + Q ) / {Q}_{max} = SoC 0 / \% + 1 \; 00 Q / {Q}_{max}$$

Q₀/mAh=Initial charge of the battery.

Q/mAh=The quantity of electricity delivered by or supplied to, the battery. It follows the convention of the current: it is negative during the discharge and positive during the charge.

Qₘₐₓ/mAh=The maximum charge that can be stored in the battery.

$${SoC}_{0} / \% = \text{The initial state-of-charge} ( SoC / \% ) \text{of the battery} .$$

If the battery is new: Qmax=Cᵣ and Q₀=0.5Qₘₐₓ, where Cᵣ is the rated capacity of the battery as given by the manufacturer.

If the battery is fully charged: Q₀=Qₘₐₓ and SoC₀=100%

The SoC value may be determined by monitoring the charge of the battery (measurement of the current and the time).

The state-of-health (SoH) of a battery describes the difference between a battery being studied and a fresh battery and considers cell aging. SoH may be defined as the ratio of the maximum battery charge to its rated capacity. SoH may be expressed as a percentage as seen below.

$$SoH / \% = 100 {Q}^{max} / {C}_{r}$$

Qₘₐₓ/mAh=The maximum charge available of the battery

Cᵣ=The rated capacity

The transportable charger may display real-time data via a local display, such as current charging power (KW), energy delivered (kWh), battery state of charge (SoC), state-of-health, and/or charging duration.

Optionally, charging session data may be wirelessly transmitted in real time by the charging system to an application hosted on a remote device or to a system hosting a web interface, wherein a user may monitor the charging session in real time.

At block 312, a determination may be made as to whether there is a vehicle fault based on the monitored data. Such faults may include electrical faults. For example, an overcurrent condition may be detected (e.g., when the current flowing to the vehicle being charged exceeds the vehicle's or charging system's rated capacity). Overcurrent may cause overheating, damage to the charging system and/or electric vehicle's components, and/or pose a fire risk. By way of further example, an overvoltage condition may be detected (e.g., when the voltage supplied to vehicle exceeds safe operating limits). Overvoltage can damage the vehicle's battery and/or electronic systems. By way of additional example, a ground fault may be detected when there is an unintended connection between an electrical circuit and the earth (ground). A ground fault may cause electric shock hazards or damage to the charging system and/or the electric vehicle.

If no material fault is detected, at block 320, a determination is made as to whether charging is complete (e.g., is fully charged or has reached a programmed state of charge (SoC)). If charging is complete, at block 322, the charging process may be halted

A charge completion notification may be displayed and may be transmitted for in real time display on a remote device (e.g., via an installed application or via a web page presented by a browser). Optionally, the charging system may automatically turn itself off (e.g., turn off entirely or go into a standby mode).

The charging system may maintain a log of all the session data (e.g., energy delivered, charging duration, start and end times, SoC data, SoH data, faults or anomalies, and/or the like) and may transmit the logs to one or more remote destinations (e.g., user handheld devices, a vehicle charging management system, a data collection system, and/or the like).

If, at block 312 a fault is detected, at block 314 one or more remedial actions may be taken. Optionally, one or more remediation actions may be determined based on the type(s) of faults detected. Optionally, a sequence of remediation actions may be specified, wherein once the detected fault(s) are resolved (e.g., as may be determined by attempting to charge the vehicle and determining if the fault(s) are still detected), the sequence may stop. Instructions for such remediation actions may be displayed to a user to enable the user to perform such actions, and/or the remediation actions may be transmitted to one or more remote systems, which can perform or initiate the performance of such remediation actions. The charging system may electronically transmit certain commands to the vehicle to take certain remediation actions. Optionally, the remediation actions will be determined in whole or in part by the remote system.

For example, a sequence of remediation actions may include, as a first action, determining if the vehicle software needs to be updated with a new version. If it is determined that the software needs to be updated, the software may accordingly be updated (e.g., using a wireless download of a different version of the software). If the software does not need to be updated, or the software was updated but the fault is still detected, the vehicle may be powered down and then powered up. If the power down/power up operation does not succeed in resolving the faults other remediation actions may be specified and performed, such as initiating a process of having the vehicle transported (e.g., using a transporter) from a current location (e.g., a transporter or storage area) to a repair location where a repair operation may be performed (e.g., the replacement of electronics, cabling, batteries, and/or the like)).

At block 316, a determination is made as to whether the remediation actions have been successfully completed and the faults rectified. If the remediation actions have not been successfully completed, further remediation attempts may be taken. If the remediation actions have been successfully completed, at block 318, the vehicle may be redeployed (e.g., delivered to its originally intended destination, such as a vehicle dealership).

Thus, technical solutions are disclosed that address challenges in electric vehicle transport and charging.

An aspect of the present disclosure relates to a vehicle charging system, comprising: a charging cable configured to electrically couple a vehicle to the vehicle charging system and to transmit charging power to the vehicle and to transmit communications between the vehicle and the vehicle charging system; at least one processing device; non-transitory memory that stores programmatic instructions that when executed by the at least one processing device cause the system to perform operations comprising: access over the charging cable vehicle data from the vehicle; use the vehicle data to determine charging parameters; deliver charging power to the vehicle over the charging cable in accordance with the charging parameters; perform a safety check on the vehicle; and at least partly in response to detection of a fault during the performance of the safety check or during charging of the vehicle, inhibit charging of the vehicle and initiate remediation action.

Optionally, the system comprises a housing, a plurality of wheels supporting the housing, and a reel configured to hold the charging cable. Optionally, the safety check comprises detection of ground faults and short circuits. Optionally, vehicle data comprises a charging volage and/or charging current. Optionally, the system is configured to monitor a charging voltage, charging current, and/or charging rate during the charging of a given vehicle. Optionally, the system is configured to transmit an electronic communication to one or more destinations at least partly in response to detecting the fault. Optionally, the system is configured to transmit an electronic communication to one or more destinations at least partly in response to detecting the fault, the electronic communication comprising some or all of the vehicle data and fault identification data. Optionally, the system is configured to transmit to a remote device and/or display real time data regarding current charging power, energy delivered, and battery state of charge while charging a given vehicle. Optionally, the system is configured to maintain a log in memory of data regarding current charging power, energy delivered, and battery state of charge related to charging a given vehicle. Optionally, the remediation action comprises a sequence of remediation actions. Optionally, the remediation action comprises an update of vehicle software, a recycling of vehicle power, a transport of the vehicle to a first location, and/or a replacement of one or more vehicle components.

An aspect of the present disclosure relates to computer implemented method, the method comprising: accessing over a charging cable vehicle data from a vehicle; using the vehicle data to determine charging parameters; delivering charging power to the vehicle over the charging cable in accordance with the charging parameters; performing a safety check on the vehicle; and at least partly in response to detection of a fault during the performance of the safety check or during charging of the vehicle, inhibiting charging of the vehicle and initiating remediation action.

Optionally, the safety check comprises detection of ground faults and short circuits. Optionally, vehicle data comprises a charging volage and/or charging current. Optionally, the method further comprises transmitting an electronic communication to one or more destination at least partly in response to detecting the fault. Optionally, the method further comprises transmitting an electronic communication to one or more destination at least partly in response to detecting the fault, the electronic communication comprising some or all of the vehicle data and fault identification data. Optionally, the method further comprises transmitting to a remote device and/or display real time data regarding current charging power, energy delivered, and battery state of charge while charging a given vehicle. Optionally, the method further comprises maintaining a log in memory of data regarding current charging power, energy delivered, and battery state of charge related to charging a given vehicle. Optionally, the method further comprises the remediation action comprises a sequence of remediation actions. Optionally, the method further comprises the remediation action comprises an update of vehicle software, a recycling of vehicle power, a transport of the vehicle to a first location, and/or a replacement of one or more vehicle components.

The methods and processes described herein may have fewer or additional steps or states and the steps or states may be performed in a different order. Not all steps or states need to be reached. The methods and processes described herein may be embodied in, and fully or partially automated via, software code modules executed by one or more general purpose computers. The code modules may be stored in any type of computer-readable medium or other computer storage device. Some or all of the methods may alternatively be embodied in whole or in part in specialized computer hardware. The systems described herein may optionally include displays, user input devices (e.g., touchscreen, keyboard, mouse, voice recognition, etc.), network interfaces, etc.

The results of the disclosed methods may be stored in any type of computer data repository, such as relational databases and flat file systems that use volatile and/or non-volatile memory (e.g., magnetic disk storage, optical storage, EEPROM and/or solid state RAM).

The various illustrative logical blocks, modules, routines, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “may,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

While the phrase “click” may be used with respect to a user selecting a control, menu selection, or the like, other user inputs may be used, such as voice commands, text entry, gestures, etc. User inputs may, by way of example, be provided via an interface, such as via text fields, wherein a user enters text, and/or via a menu selection (e.g., a drop down menu, a list or other arrangement via which the user can check via a check box or otherwise make a selection or selections, a group of individually selectable icons, etc.). When the user provides an input or activates a control, a corresponding computing system may perform the corresponding operation. Some or all of the data, inputs and instructions provided by a user may optionally be stored in a system data store (e.g., a database), from which the system may access and retrieve such data, inputs, and instructions. The notifications/alerts and user interfaces described herein may be provided via a Web page, a dedicated or non-dedicated phone application, computer application, a short messaging service message (e.g., SMS, MMS, etc.), instant messaging, email, push notification, audibly, a pop-up interface, and/or otherwise.

The user terminals described herein may be in the form of a mobile communication device (e.g., a cell phone), laptop, tablet computer, interactive television, game console, media streaming device, head-wearable display, networked watch, etc. The user terminals may optionally include displays, user input devices (e.g., touchscreen, keyboard, mouse, voice recognition, etc.), network interfaces, etc.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

What is claimed is:

1. A vehicle charging system, comprising:
a charging cable configured to electrically couple a vehicle to the vehicle charging system and to transmit charging power to the vehicle and to transmit communications between the vehicle and the vehicle charging system;
at least one processing device;
non-transitory memory that stores programmatic instructions that when executed by the at least one processing device cause the system to perform operations comprising:
access over the charging cable vehicle data from the vehicle;
use the vehicle data to determine charging parameters;
deliver charging power to the vehicle over the charging cable in accordance with the charging parameters;
perform a safety check on the vehicle; and
at least partly in response to detection of a fault during the performance of the safety check or during charging of the vehicle, inhibit charging of the vehicle and initiate remediation action.

2. The system as defined in claim 1, the system comprising a housing, a plurality of wheels supporting the housing, and a reel configured to hold the charging cable.

3. The system as defined in claim 1, wherein the safety check comprises detection of ground faults and short circuits.

4. The system as defined in claim 1, wherein vehicle data comprises a charging volage and/or charging current.

5. The system as defined in claim 1, wherein the system is configured to monitor a charging voltage, charging current, and/or charging rate during the charging of a given vehicle.

6. The system as defined in claim 1, wherein the system is configured to transmit an electronic communication to one or more destinations at least partly in response to detecting the fault.

7. The system as defined in claim 1, wherein the system is configured to transmit an electronic communication to one or more destinations at least partly in response to detecting the fault, the electronic communication comprising some or all of the vehicle data and fault identification data.

8. The system as defined in claim 1, wherein the system is configured to transmit to a remote device and/or display real time data regarding current charging power, energy delivered, and battery state of charge while charging a given vehicle.

9. The system as defined in claim 1, wherein the system is configured to maintain a log in memory of data regarding current charging power, energy delivered, and battery state of charge related to charging a given vehicle.

10. The system as defined in claim 1, wherein the remediation action comprises a sequence of remediation actions.

11. The system as defined in claim 1, wherein the remediation action comprises an update of vehicle software, a recycling of vehicle power, a transport of the vehicle to a first location, and/or a replacement of one or more vehicle components.

12. A computer implemented method, the method comprising:
accessing over a charging cable vehicle data from a vehicle;
using the vehicle data to determine charging parameters;
delivering charging power to the vehicle over the charging cable in accordance with the charging parameters;
performing a safety check on the vehicle; and
at least partly in response to detection of a fault during the performance of the safety check or during charging of the vehicle, inhibiting charging of the vehicle and initiating remediation action.

13. The method as defined in claim 12, wherein the safety check comprises detection of ground faults and short circuits.

14. The method as defined in claim 12, wherein vehicle data comprises a charging volage and/or charging current.

15. The method as defined in claim 12, the method further comprising transmitting an electronic communication to one or more destinations at least partly in response to detecting the fault.

16. The method as defined in claim 12, the method further comprising transmitting an electronic communication to one or more destinations at least partly in response to detecting the fault, the electronic communication comprising some or all of the vehicle data and fault identification data.

17. The method as defined in claim 12, the method further comprising transmitting to a remote device and/or display real time data regarding current charging power, energy delivered, and battery state of charge while charging a given vehicle.

18. The method as defined in claim 12, the method further comprising maintaining a log in memory of data regarding current charging power, energy delivered, and battery state of charge related to charging a given vehicle.

19. The method as defined in claim 12, wherein the remediation action comprises a sequence of remediation actions.

20. The method as defined in claim 12, wherein the remediation action comprises an update of vehicle software, a recycling of vehicle power, a transport of the vehicle to a first location, and/or a replacement of one or more vehicle components.
